(19) United States
(12) Patent Application Publication
(10) Pub. No.: US 2024/0020680 A1
(43) Pub. Date: Jan. 18, 2024

(54) APPARATUS AND METHOD FOR PROVIDING ANONYMOUS DELEGATED CREDENTIAL IN DID-BASED SERVICE

(71) Applicant: ELECTRONICS AND TELECOMMUNICATIONS RESEARCH INSTITUTE, Daejeon (KR)

(72) Inventors: Kwan-Tae CHO, Daejeon (KR); Sang-Rae CHO, Daejeon (KR); Soo-Hyung KIM, Daejeon (KR); Geon-Woo KIM, Daejeon (KR); Seok-Hyun KIM, Daejeon (KR); Young-Sam KIM, Daejeon (KR); Jong-Hyouk NOH, Daejeon (KR); Young-Seob CHO, Daejeon (KR); Jin-Man CHO, Daejeon (KR); Seung-Hun JIN, Daejeon (KR)

(21) Appl. No.: 18/189,029

(22) Filed: Mar. 23, 2023

(30) Foreign Application Priority Data
Jul. 18, 2022 (KR) 10-2022-0088401

(51) Int. Cl. G06Q 20/36; H04L 9/32

(52) U.S. Cl. CPC G06Q 20/3672; H04L 9/3236; H04L 9/3247; H04L 2209/56; G06Q 2220/00

(57) ABSTRACT

Disclosed herein are an apparatus and method for providing an anonymous delegated credential in a DID-based service. A method for issuing an anonymous delegated credential in a DID-based service includes receiving an anonymous delegated credential issuance request message from a digital wallet of a delegate, setting attribute values in the anonymous delegated credential, anonymizing delegator identification information and delegatee identification information among the attribute values, and issuing the generated anonymous delegated credential to the digital wallet of the delegatee.

### CROSS REFERENCE TO RELATED APPLICATION

This application claims the benefit of Korean Patent Application No. 10-2022-0088401, filed Jul. 18, 2022, which is hereby incorporated by reference in its entirety into this application.

### BACKGROUND OF THE INVENTION

### 1. Technical Field

The following embodiments relate generally to a method and apparatus for providing a function for anonymizing a user in a delegated credential in order to prevent in advance the leakage of user personal information that may occur when a verifiable credential is delegated in a Decentralized ID (DID)-based service environment in which a user personally determines whether to and how to use his/her own personal information.

### 2. Description of the Related Art

Subjects constituting a DID-based service framework are typically divided into an issuer, an owner, a verifier, and a DID registry according to the roles and interactions with a verifiable credential (hereinafter, referred to as a credential).

The issuer generates a credential including requirements of the user, does his or her job for issuing the generated credential to the user, and manages information about the issued credential. The owner holds the credential, and generates a verifiable presentation (hereinafter, referred to as a presentation) to present the credential to a service provider. The verifier verifies the presentation presented by the user, and provides a service granted to the user. In addition, the DID registry provides functions for the issuer, the owner, and the verifier to be able to store DID documents, and retrieve the documents. For reference, there may be multiple issuers, multiple owners, multiple verifiers, and multiple DID registries in a DID-based service.

Although such a DID-based service is not yet popularized in Korea, various pilot projects are currently being operated or constructed under government supervision. For example, the Gyeongsangnam-do Provincial Office has overseen a pilot project for smart inhabitant cards since 2019, and Military Manpower Administration has provided an easy authentication service since January 2020. Further, the Ministry of Public Administration and Security started to provide mobile identification cards for public offices to government employees in Sejong/Seoul government offices in January, 2021 and is scheduled to gradually expand the corresponding service to local governments. In Sejong, unlike other pilot projects, a construction project for a trusted autonomous driving platform, which is a pilot project, the range of which expands from identity authentication to the identity of things, is being conducted. It is expected that the targets of DID-based service will expand to various public/private fields in the future owing to many advantages such as the prevention of excessive leakage of personal information, reduction in social costs, and the improvement of convenience.

Typically, in an off-line environment, a delegator is sometimes required to designate a delegatee who substitutes himself/herself, and temporally delegates the authority of and ID information about the delegator to the delegatee. For example, a legal delegatee may perform exercise of authority on behalf of a minor, vicarious payment, conservatorship, creation of a letter of authorization or the like. Similar to the letter of authorization in the off-line environment, a user in a DID-based service environment is also sometimes required to temporally delegate his/her credential to another user. For example, a service provider may require the user to delegate the authority for checking financial information or health information about the user during joining a service.

Similar to the previous version of Verifiable Credentials Data Model 1.0, W3C Recommendation, “Verifiable Credentials Data Model 1.1, W3C Recommendation” revised in March 2022 only refers to delegation necessity for a verifiable credential, but does not present a related model or method. Regarding this, a credential delegation model in a DID-based service environment is standardized in 2021 in South Korea, and related patents have been applied.

The delegated credential in the DID-based service environment may be issued for consecutive re-delegations. For example, it is assumed that user 1 has been issued a credential (original credential) having a specific authority written therein. When user 1 tries to temporally delegate the specific authority to user 2, user 1 may issue, to user 2, a first-degree delegated credential for the original credential. In addition, user 2 may issue a second-degree delegated credential in order to re-delegate the same to user 3. In this way, user 3 may issue a third-degree delegated credential to user 4 who is an end user. In addition, according to the delegated credential characteristics, the content of the specific authority is included only in the original credential, and thus, in order for user 4 to be verified by the verifier that he or she is the legal person who has been finally delegated the specific authority, he or she has to provide all of the original credential and the first-degree to third-degree credentials to the verifier.

For reference, according to the standard specification, all credentials include identifiers of respective issuers as basic attribute values. However, in general, for such consecutive delegations, the verifier may be required to identify only a fourth-degree user in order to authenticate a service user, but needs not know the identifier of user 1 who is the first-degree delegator, the identifier of user 2 who is the second-degree delegator, and the identifier of user 3 who is the third-degree delegator. Merely, the verifier needs to verify the fact that the first-degree delegator (user 1), the second-degree delegator (user 2), and the third-degree delegator (user 3) delegated the authority to user 4 in the legal way.

In other words, if the delegate credentials up to an n-th-degree are issued for the original credential in which the specific authority is specified, in order for the n-th-degree delegator to exercise the specific authority, the n-th-degree delegator should provide all of the original credential and the first to (n−1)-th-degree delegated credentials to the verifier. Here, the verifier only needs to confirm that the delegations performed in the legal way between the delegators (issuers) without leakage of the identification information from the first to (n−1)-th-degree delegators (issuers).

### SUMMARY OF THE INVENTION

An embodiment is intended to provide an apparatus and method for solving the problem of unnecessary leakage of personal information while maintaining the previous delegation function without change, when consecutive delegated credentials are issued in a DID-based service.

In accordance with an aspect of the present disclosure, there is provided a method for issuing an anonymous delegated credential in a DID-based service, including receiving an anonymous delegated credential issuance request message from a digital wallet of a delegate, setting attribute values in the anonymous delegated credential, anonymizing delegator identification information and delegatee identification information among the attribute values, and issuing the generated anonymous delegated credential to the digital wallet of the delegatee.

The anonymizing may include extracting and anonymizing the delegatee identification information included in the anonymous delegated credential issuance request message.

The anonymizing may include anonymizing each of the delegator identification information and the delegatee identification information based on a cryptographic one-way hash function.

The anonymizing may further include inputting a character string in which issuance dates are respectively connected to the delegator identification information and the delegatee identification information to the cryptographic one-way hash function.

The method may further include computing a signature value for the attribute values included in the anonymous delegated credential.

The anonymous delegated credential may be specified in a type attribute among the attribute values.

In accordance with another aspect of the present disclosure, there is provided a method for verifying an anonymous delegated credential in a DID-based service, including acquiring attribute values necessary for verification from an anonymous delegated credential issued from a digital wallet of a delegator, verifying first anonymous delegator identification information and first anonymous delegatee identification information among the attribute values included in the anonymous delegated credential according to a delegation degree of the anonymous delegated credential, and verifying an electronic signature value included in the anonymous delegated credential.

Verifying the first anonymous delegator identification information and the first anonymous delegatee identification information may be performed when a k-th-degree delegatee is issued a k-th-degree anonymous delegated credential.

The attributes necessary for verification may include the first anonymous delegator identification information, the first anonymous delegatee identification information, an issuance date, and the electronic signature value.

Verifying the first anonymous delegator identification information and the first anonymous delegatee identification information may include computing second anonymous delegator identification information based on delegator identification information included in an anonymous delegated credential issuance message, determining whether the first anonymous delegator identification information is identical to the second anonymous delegator identification information, computing second anonymous delegatee identification information based on delegatee identification information, and determining whether the first anonymous delegatee identification information is identical to the second anonymous delegatee identification information.

Computing the second anonymous delegator identification information and computing the second anonymous delegatee identification information may be performed using a cryptographic one-way hash function.

Computing the second anonymous delegator identification information and computing the second anonymous delegatee identification information may be performed by inputting, to a cryptographic one-way hash function, a character string in which issuance dates are respectively connected to the delegator identification information and the delegatee identification information.

In accordance with a further aspect of the present disclosure, there is provided an apparatus for providing an anonymous delegated credential in a DID-based service, including memory configured to store at least one program, and a processor configured to execute the program, wherein the program is configured to perform receiving an anonymous delegated credential issuance request message from a digital wallet of a delegate, setting attribute values in the anonymous delegated credential, anonymizing delegator identification information and delegatee identification information among the attribute values, and issuing the generated anonymous delegated credential to the digital wallet of a delegatee.

The program may be configured to further perform, in the anonymizing, extracting and anonymizing the delegatee identification information included in the anonymous delegated credential issuance request message.

The program may be configured to further perform, in the anonymizing, anonymizing each of the delegator identification information and the delegatee identification information based on a cryptographic one-way hash function.

The program may be configured to further perform, in the anonymizing, inputting, to the cryptographic one-way hash function, a character string in which issuance dates are respectively connected to the delegator identification information and the delegatee identification information.

The program may be configured to further perform computing a signature value for the attribute values included in the anonymous delegated credential.

The anonymous delegated credential may be specified in a type attribute among the attribute values.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a configuration diagram of an anonymous delegated credential service framework in a DID-based service according to an embodiment;

FIG. 2 illustrates an example of an anonymous delegated credential data model according to an embodiment;

FIGS. 3 and 4 illustrate examples of a hierarchical anonymous delegated credential according to embodiments;

FIG. 5 is a flowchart for explaining a method for issuing an anonymous delegated credential in a DID-based service according to an embodiment;

FIG. 6 is a flowchart for explaining a method for verifying an anonymous delegated credential in a DID-based service according to a first embodiment;

FIG. 7 is a flowchart for explaining a method for verifying an anonymous delegated credential in a DID-based service according to a second embodiment; and

FIG. 8 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

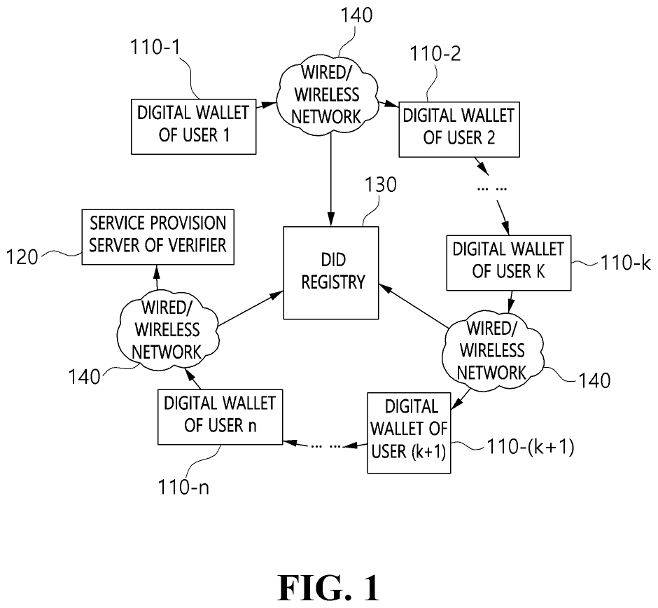

Hereinafter, an apparatus and method for providing an anonymous delegated credential in a DID-based service according to embodiments will be described in detail with reference to FIGS. 1 to 8.

The embodiments disclosed herein prevents in advance personal information about each user from unnecessary leakage to a verifier (service provider) or a delegatee by granting anonymity to a user identification attribute value in a delegated credential, when a plurality of delegated credentials are issued for consecutive re-delegations between users in a DID-based service environment. In addition, the verifier or the delegatee may be allowed to verify that delegation is made between users in the legal way.

In other words, the embodiment relates to a method for defining the anonymous delegated credential in which the anonymity is granted to the delegated credential, and issues and verifies such an anonymous delegated credential.

Typically, in a credential service, a company/organization issues a credential to an individual user. However, similar to the delegated credential, a main issuance subject of the anonymous delegated credential is expected to be frequently used when a user, rather than the company/organization, delegates a credential owned by himself/herself to another user other than him/her. According, subjects constituting an anonymous delegated credential service framework may be constituted with multiple users, and a user may be an issuer who issues an anonymous delegated credential and also serve as an owner who is issued an anonymous delegated credential. In addition, an issuer who issues an anonymous delegated credential is also a delegator, and an owner who is issued an anonymous delegated credential is also a delegatee.

FIG. 1 is a configuration diagram of an anonymous delegated credential service framework in a DID-based service according to an embodiment.

Referring to FIG. 1, the anonymous delegated credential service framework in a DID-based service has a configuration in which digital wallets 110-1, 110-2, . . . , 110-k, 110-(k+1), . . . , 110-n owned by n respective users, a service provision server 120 of a verifier, and a DID registry 130 interact over a wired/wireless network 140.

Here, the digital wallets 110-1, 110-2, . . . , 110-k, 110-(k+1), . . . , 110-n may be hardware apparatuses of users or software installed in user terminals for storing and managing credentials.

The DID registry 130 may be a server for the digital wallets 110-1, 110-2, . . . , 110-k, 110-(k+1), . . . , 110-n owned by n respective users to retrieve and acquire DID documents necessary for issuing anonymous delegated credentials.

Referring to FIG. 1, the digital wallet 110-1 of user 1 is assumed to have stored an issued credential, and tries to sequentially perform an anonymous delegated credential issuance procedure for the issued credential from user 2 to user n.

In other words, the digital wallet 110-1 of user 1 issues a first-degree anonymous delegated credential to the digital wallet 110-2 of user 2 through the wired/wireless network 140 in order to delegate the issued credential (original credential), and the digital wallet 110-2 of user 2 issues a second-degree anonymous delegated credential to the digital wallet of user 3 through the wired/wireless network 140 in order to re-delegate the first-degree anonymous delegated credential issued from the digital wallet 110-1 of user 1. In this way, the issuances of the anonymous delegated credentials may be applied up to user n.

Finally, the digital wallet 110-n of user n presents all the transferred credentials (the original credential and all the anonymous delegated credentials) to the service provision server 120 of a verifier over the wired/wireless network 140.

Then, the service provision server 120 of a verifier verifies all the presented credentials and provides the service to user n, when all the credentials are determined as valid. In other words, user n receives the service from the verifier based on the authority delegated from user 1.

Here, the service provision server 120 of a verifier receives the original credential and (n−1) anonymous delegated credentials from user n.

The original credential may include the content for the service authority of user 1, and the (n−1) anonymous delegated credentials may include authority delegation facts between the users.

According to an embodiment, pieces of personal identification information about users may be anonymized to be protected. In other words, the service provision server 120 of a verifier may not acquire the pieces of personal identification information about user 1 to user (n−1) other than user n who is a service user, from the (n−1) anonymous delegated credentials. The service provision server 120 of a verifier may only confirm that the service authority delegated from user 1 is legal.

However, the protection of personal identification information about the users may be applied to intermediate users. For example, it is assumed that user k issues a k-th (where 1≤k≤n)-degree delegated credential to user (k+1) in order to re-delegate a (k-1)-th-degree delegated credential issued from user (k−1).

Here, user (k+1) is issued a k-th-degree delegated credential from user k, and is required to acquire and authenticate personal identification information about user k in order to authenticate user k who is an issuer. However, it is not necessary to acquire the pieces of identification information about user 1 to user (k−1) in the previous first-degree to (k−1)-th-degree delegated credentials. In addition, for personal information protection of user 1 to user (k−1), the pieces of identification information should be anonymized so as not to be acquired.

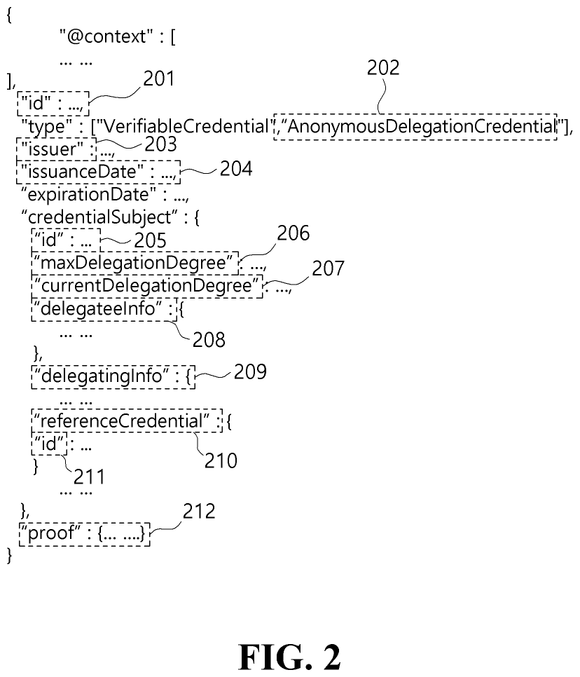

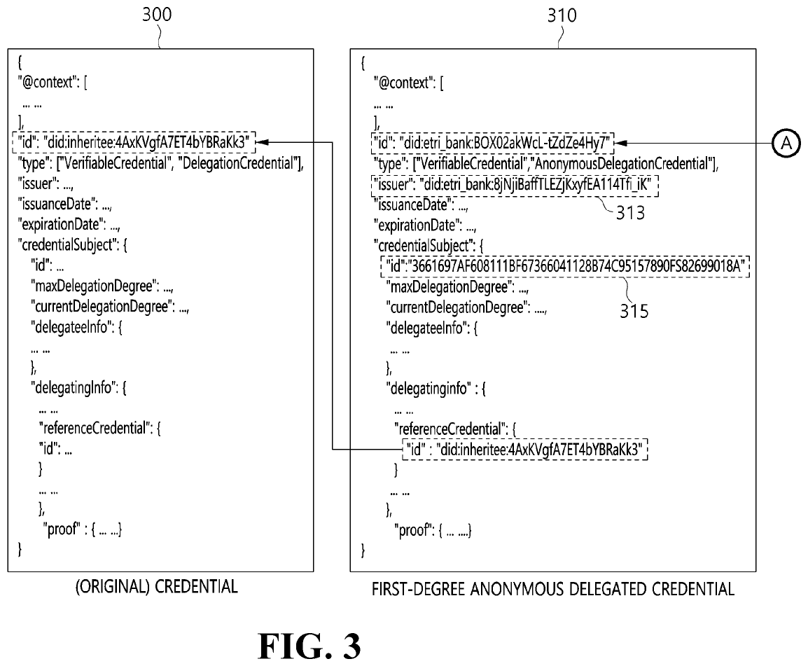

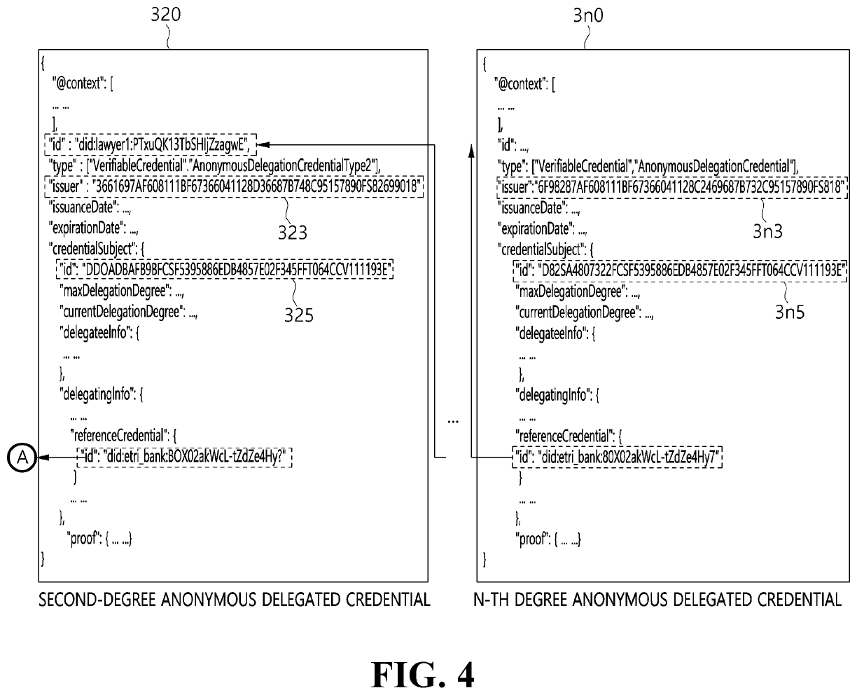

FIG. 2 illustrates an example of an anonymous delegated credential data model according to an embodiment, and FIGS. 3 and 4 illustrate examples of hierarchical anonymous delegated credentials according to embodiments.

The anonymous delegated credential data model according to the embodiment complies with the verifiable W3C data model standard, and follows the JSON format.

Referring to FIG. 2, the anonymous delegated credential data model according to the embodiment includes the attributes such as “@context”, “id” 201, “type”, “issuer” 203, “issuanceDate” 204, “expirationDate”, “credentialSubject”, “proof” 212 or the like. The purposes of using the attributes are the same as the uses of the verifiable data model standard.

However, “type” may include a value of “AnonymousDelegationCredential” 202 that is the attribute defined to specify the anonymous delegated credential.

In addition, “issuer” 203 is the attribute indicating identification information about the issuer (the delegator), and “issuanceDate” 204 is the attribute meaning an issuance date of the anonymous delegated credential.

Further, “id” 205 in “credentialSubject” is the attribute indicating the identification information about the owner (the delegatee).

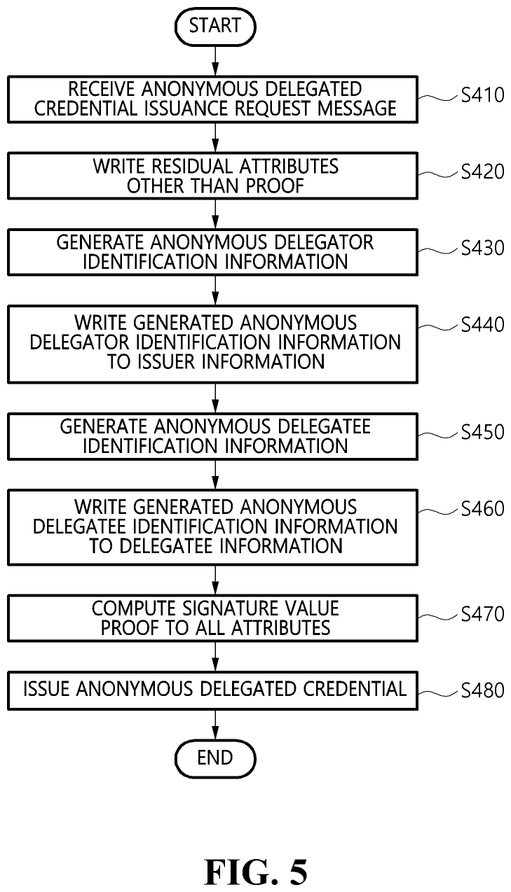

According to the embodiment, “issuer” 203, which is the identification information about the delegator, and “id” 205, which is the identification information about the delegatee may be anonymized. In other words, when the anonymous delegated credential is issued, depending on whether the anonymity is required, the delegator identification information and the delegatee identification information may be allocated as anonymized values that are not actual identifiers. Detailed description thereof will be provided below with reference to FIG. 5.

Referring back to FIG. 2, “maxDelegationDegree” 206 is a maximal degree of delegation and is determined by the first-degree delegator, and “currentDelgationDegree” 207 means the current degree of delegation.

In addition, “delegateeInfo”208, “delegatingInfo” 209, “referenceCredential” 210, “id” 211 are the attributes defined in the anonymous credential, and are adopted in the anonymous delegated credential as the same meaning without a change.

Here, attribute “delegateeInfo” 208 includes delegatee information, namely, information about a subject who is issued the anonymous delegated credential, and attribute “delegatingInfo” 209 includes delegation information intended to be delegated.

The delegation information may include information about a subject to be delegated and information about the delegator. In addition, attribute “referenceCredential” 210 includes information about the original credential intended to be delegated or information about an upper layer delegated credential intended to be delegated, and attribute “id” 211 includes an identifier of the credential intended to be delegated.

For example, it is assumed that there are two anonymous delegated credentials A, B. A value of “Id” 201 of the anonymous delegated credential A to be delegated should be given to “id” 211 of the anonymous delegated credential B. In other words, the credential identifier to be delegated is given.

Referring to FIGS. 3 and 4, an example of the case where the anonymous delegated credentials up to an n-th-degree are consecutively issued based on the original credential is illustrated.

An anonymous delegated credential data model according to an embodiment may generate consecutive anonymous delegated credentials by inputting the identifier attribute value 201 of an upper layer delegated credential to the credential identifier attribute 211 of a credential intended to be delegated, and has no limit to the degree of delegation of the anonymous delegated credential to be able to be issued.

With reference to FIGS. 3 and 4, the credential identifier 210 of the original credential 300 is given to the identifier attribute 211 of the credential intended to be delegated in the first-degree anonymous delegated credential 310. In addition, in order to generate a second-degree anonymous delegated credential 320, the identifier 201 of the first-degree anonymous delegated credential 310 is given to the identifier attribute 211 of a credential intended to be delegated. When the delegations up to the n-th-degree are performed, n anonymous delegated credentials may be defined, and an identifier value of the (n−1)-th-degree anonymous delegated credential is input to the identifier attribute 211 intended to be delegated in the n-th-degree anonymous delegated credential.

For the delegator identification information 313 and the delegatee identification information 315 in the first-degree anonymous delegated credential, the delegator identification information 323 and the delegatee identification information 325 in the second-degree anonymous delegated credential, and the delegator identification information 3n3 and the delegatee identification information 3n5 in the n-th-degree anonymous delegated credential, namely, for the delegator identification information and the delegatee identification information in a k-th (where 1≤k≤n)-degree anonymous delegated credential, a k-th-degree issuer (delegator) may provide the anonymity by replacing actual identifier values with anonymized values depending on whether the anonymity is required.

Finally, similar to the definition in the verifiable W3C data model standard, the attribute “proof” 212 stores pieces of information about signature values for all the attribute values in the anonymous delegated credential and cryptographic computations therefor.

FIG. 5 is a flowchart for explaining a method for issuing an anonymous delegated credential in a DID-based service according to an embodiment. The flowchart illustrates an example method for anonymizing the delegator identification information and the delegatee identification information in the anonymous delegated credential issued by the delegator (issuer) to the delegatee (owner).

Referring to FIG. 5, as the delegator receives a credential issuance request message from the delegatee at step S410, the delegator starts to generate an anonymous delegated credential to be issued to the delegatee.

Here, the delegator checks the credential issuance request message to acquire the delegatee identification information given_holder_id.

Then, the delegator writes each value of the attributes included in the anonymous delegated credential at step S420. In other words, the delegator fills the attributes illustrated in FIG. 2 with corresponding values except for an electron signature value proof.

Then, the delegator anonymizes his or her identification information idᵢₛₛᵤₑᵣ to generate anonymous delegator identification information AnonIDᵢₛₛᵤₑᵣ at step S430. Here, whether the delegator identification information is to be anonymized may be optionally determined according to the requirements of the anonymous delegated credential service.

Here, the anonymous delegator identification information AnonIDᵢₛₛᵤₑᵣ may be calculated as the following Equation (1).

AnonIDᵢₛₛᵤₑᵣ=Hash(idᵢₛₛᵤₑᵣ∥issuanceDate) (1)

In Equation (1), idᵢₛₛᵤₑᵣ denotes the delegator identification information, issuanceDate denotes an issuance date of the anonymous delegated credential, Hash(·) is a cryptographic one-way hash function, and A∥B denotes a mathematical symbol for connecting character string A and character string B to generate one character string.

Here, the credential issuance date issuanceDate may be used for unlinkability. Here, the unlinkability means that when two pieces of anonymous identification information are present for the same user, it is required that an attacker cannot know that the two pieces of anonymous identification information are of the same person.

As described above, the delegator writes the generated anonymous delegator identification information AnonIDᵢₛₛᵤₑᵣ to the delegator identification information in the anonymous delegator credential at step S440.

Then, the delegator anonymizes the delegatee identification information give_holder_id extracted at step 410 to generate the anonymous delegatee identification information AnonID_{holder} at step S450. Here, whether the delegatee identification information is to be anonymized may be optionally determined according to the requirements of the anonymous delegated credential service.

Here, the anonymous delegatee identification information AnonID_{holder} may be calculated as the following Equation (2).

AnonID_{holder}=Hash(given_holder_id∥issuanceDate (2)

In Equation (2), given_holder_id denotes the delegatee identification information, issuanceDate denotes an issuance date of the anonymous delegated credential, Hash(·) is a cryptographic one-way hash function, and A∥B denotes connecting character string A and character string B to generate one character string.

Then, the delegatee writes the generated anonymous delegatee identification information AnonID_{holder} to the delegatee identification information “id” 205 in the anonymous delegated credential at step S460.

Finally, the delegator calculates a signature value proof for all the attributes of the anonymous delegated credential to complete the generation of the anonymous delegated credential at step S470, and then issues the anonymous delegated credential to the delegatee at step S480.

Here, according to an embodiment, an anonymous signature (group signature) may be used to calculate the signature value at step S470. As a representative anonymous signature scheme, there is BBS+ that is considered as W3C standard, because BBS+ enables optional anonymous signature for the attributes of a verifiable credential.

Then, as described above, a method for verifying the anonymous delegated credential generated by the delegator will be described.

The verification for such an anonymous delegated credential may be performed by the delegatee or the service provider in the DID-based service.

The delegatee verifies the credential by means of a public key of the delegator in order to confirm if the issued credential is normally issued. In addition, the service provider verifies the credential by means of the public key of the delegator in order to verify that the credential received from the delegatee is valid.

In a typical online/offline service, the service provider mostly provides services after authenticating the user who is a person to be serviced in a face-to-face manner or non-face-to-face manner. Thus, when providing the services, there are not many cases of requesting the anonymity of the person to be serviced.

Such an n-th-degree delegated credential service, the person to be serviced is an n-th-degree delegator. When the n-th-degree delegator who is the person to be serviced in the n-th-degree delegated credential service requests the service provider a service by using the hierarchically delegated authority, the n-th-degree delegator should present all the first to n-th-degree delegated credentials. However, each of the delegated credentials includes the delegator identification information, and thus pieces of personal information about the first to n-th-degree delegators may be leaked to the service provider. In addition to this, the pieces of personal information about the first to (k−1)-th-degree delegators may also be leaked to each k-th-degree delegatee, where 1≤k≤n.

That is because, when the k-th-degree delegatee is issued a k-th delegated credential from the k-th-degree delegator, not only the k-th-degree delegated credential but also the first to (k−1)-th-degree delegated credentials are transferred. The anonymous delegated credential service prevents in advance the risk of such personal information infringement from occurring.

There are various embodiments according to a verification subject or the degree of the anonymous delegated credential in the method for verifying the anonymous delegated credential generated by the delegator according to the present disclosure.

A first embodiment may be verification for a k-th-degree anonymous delegated credential performed by the k-th-degree delegatee (where k is 1≤k≤n).

A second embodiment may be verification for all m-th-degree anonymous delegated credentials (where m is 1≤m≤k≤n) performed by the k-th-degree delegatee.

A third embodiment may be verification for the n-th-degree anonymous delegated credential performed by the service provider.

A fourth embodiment may be verification for the first to (n−1)-th-degree anonymous delegated credentials performed by the service provider.

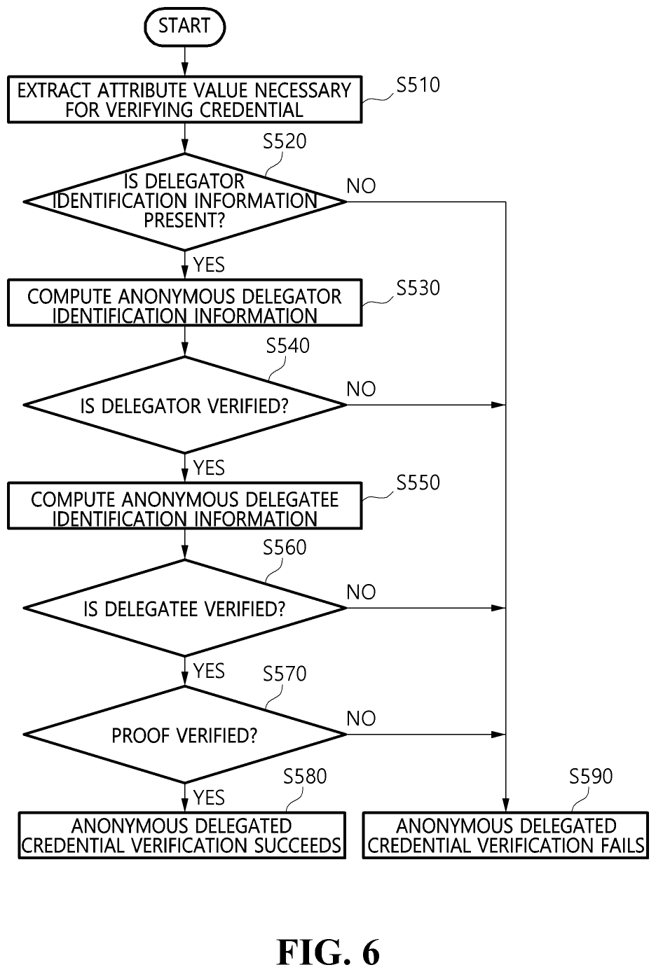

FIG. 6 is a flowchart for explaining the method for verifying an anonymous delegated credential in a DID-based service according to the first embodiment.

Referring to FIG. 6, the k-th-degree delegatee extracts attribute values required for credential verification from the k-th-degree anonymous delegated credential issued from the k-th-degree delegator at step S510.

Here, the attribute values required for the credential verification may include the anonymous delegator identification information issuer 203, the anonymous delegatee identification information d 205, the issuance date issuanceDate 204, the electronic signature value proof 212 or the like.

Here, the k-th-degree delegator should identify that the delegator having issued the anonymous delegated credential is the legal k-th-degree delegator. To this end, the k-th-degree delegator may insert his or her identification information given_issuer_id into the anonymous delegated credential issuance message to transmit the message to the k-th-degree delegatee together with the k-th-degree anonymous delegated credential.

At step 520, the k-th-degree delegatee extracts the identification information given_issuer_id about the k-th-degree delegator from the received anonymous delegated credential issuance message to determine the presence or non-presence of the identification information about the k-th-degree delegator.

As a determination result at step S520, when there is the identification information about the k-th-degree delegator, the k-th-degree delegator verifies the anonymous delegator identification information.

In other words, the k-th-degree delegator calculates the anonymous delegator identification information AnonID′ᵢₛₛᵤₑᵣ at step S530. Here, the anonymous delegator identification information A may be calculated as the following Equation (3).

AnonID′ᵢₛₛᵤₑᵣ=Hash(given_issuer_id∥issuanceDate) (3)

In Equation (3), given_issuer_id denotes the delegator identification information extracted from the anonymous delegated credential issuance message, issuanceDate denotes the issuance date of the anonymous delegated credential, Hash(·) is a cryptographic one-way hash function, and A∥B denotes a mathematical symbol for connecting character string A and character string B to generate one character string.

Then, the k-th-degree delegator verifies the delegator according to whether the calculated anonymous delegator identification information AnonID′ᵢₛₛᵤₑᵣ is identical to the delegator identification information attribute value issuer included in the issued anonymous delegated credential.

As the determination result at step S540, when the delegator is not verified, the delegator determines that the anonymous delegated credential verification fails at step S590. In other words, since the anonymous delegator identification information AnonID′ᵢₛₛᵤₑᵣ is not identical to the delegator identification information issuer, it is determined that the anonymous delegated credential has been issued by another subject who is not the k-th-degree delegator, and thus the delegator identification information is not valid.

On the other hand, when the delegator is verified as valid according to the determination result at step S540, the delegatee proceeds to an anonymous delegatee identification information verification procedure. In other words, since the anonymous delegator identification information AnonID′_{holder} is identical to the delegator identification information issuer, it is determined that the issued anonymous delegated credential has been issued by the correct k-th-degree delegator and the delegator identification information is valid.

Then, the k-th-degree delegatee calculates the anonymous delegatee identification information AnonID′_{holder} at step S550. Here, the anonymous delegatee identification information AnonID′_{holder} may be calculated as the following Equation (4).

AnonID′_{holder}=Hash(my_id∥issuanceDate) (4)

In Equation (4), my_id denotes the k-th-degree delegatee's own identification information, issuanceDate denotes the issuance date of the anonymous delegated credential, Hash(·) is a cryptographic one-way hash function, and A∥B denotes connecting character string A and character string B to generate one character string.

Then, the k-th-degree delegatee verifies the delegatee according to whether the calculated anonymous delegatee identification information AnonID′_{holder} is identical to the delegatee identification information id included in the issued anonymous delegated credential at step S560.

As a determination result at step S560, when the delegatee is verified as invalid, the delegatee determines that the anonymous delegated credential verification fails at step S590. In other words, since the anonymous delegatee identification information AnonID′_{holder}, is not identical to the delegator identification information id, the delegatee identification information about the issued anonymous delegated credential is determined as invalid.

On the other hand, when the delegatee is verified as valid according to the determination result at step S560, the k-th-degree delegatee proceeds to step S570. In other words, since the anonymous delegatee identification information AnonID′_{holder} is identical to the delegator identification information id, the delegatee identification information about the issued anonymous delegated credential is determined as valid.

Finally, the k-th-degree delegatee verifies the signature value proof included in the issued anonymous delegated credential at step S570. Here, the verification may be performed by means of an anonymous signature verification key that has been used during generation of the signature value proof of the issued anonymous delegated credential in the anonymous signature scheme.

When the signature value is valid as a verification result at step S570, the k-th-degree delegatee determines that the verification for the issued anonymous delegated credential succeeds at step S580.

On the other hand, as the verification result at step S570, when the signature value is determined as invalid, the delegatee determines that the anonymous delegated credential verification fails at step S590.

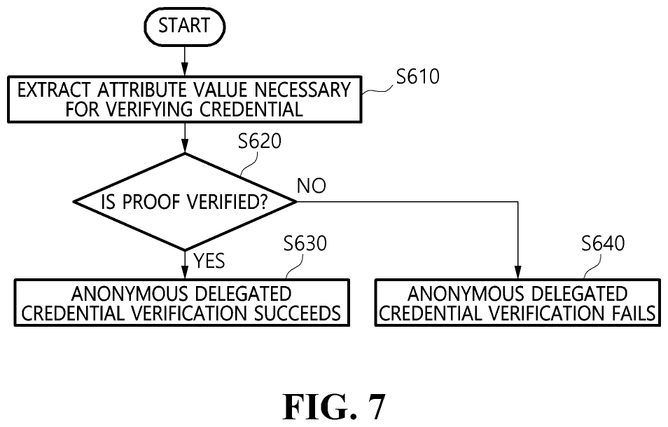

FIG. 7 is a flowchart for explaining the method for verifying an anonymous delegated credential in a DID-based service according to a second embodiment.

Referring to FIG. 7, the k-th-degree delegatee does not need to perform a procedure for verifying the anonymous delegator identification information and the anonymous delegatee identification information for all m-th-degree anonymous delegated credentials. This is because all the pieces of the delegator identification information and the delegatee identification information are respectively anonymized in the first to m-th-degree anonymous delegated credentials, and thus the delegator identification information and the delegatee identification information may not be acquired from the first to m-th-degree anonymous delegated credentials.

Accordingly, the k-th-degree delegatee extracts the electronic signature value proof of included in the m-th anonymous delegated credential at step S630, and then directly verifies the electronic signature value proof at step S620. Here, the verification may be performed by means of an anonymous signature verification key that has been used during generation of the signature value proof of the issued anonymous delegated credential in the anonymous signature scheme.

When the electronic signature value proof is valid as a verification result at step S620, the k-th-degree delegatee determines that the verification for the issued anonymous delegated credential succeeds at step S630.

On the other hand, as the verification result at step S620, when the electronic signature value proof is not valid, the delegatee determines that the anonymous delegated credential verification fails at step S640.

Meanwhile, the verification for the n-th-degree anonymous delegated credential performed by the service provider according to the third embodiment may be the same as the first embodiment illustrated in FIG. 6.

In addition, the verification for the first to (n−1)-th-degree anonymous delegated credentials performed by the service provider according to the fourth embodiment may be the same as the second embodiment illustrated in FIG. 7.

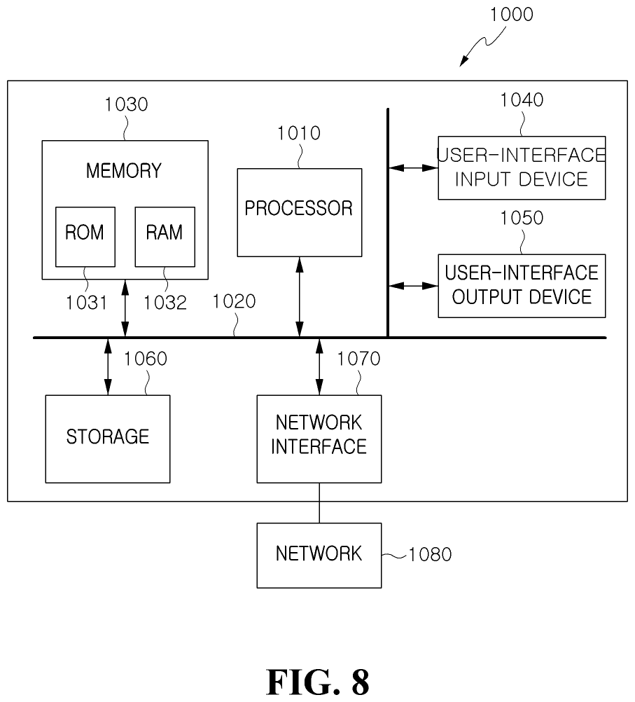

FIG. 8 is a diagram illustrating the configuration of a computer system according to an embodiment.

An apparatus for providing an anonymous delegated credential in a DID-based service according to an embodiment may be implemented in a computer system 1000 such as a computer-readable recording medium. Here, the apparatus for providing an anonymous delegated credential in a DID-based service may include the digital wallets 110-1, 110-2, . . . , 110-n of a user, the service provision server 120 of a verifier, and the DID registry 130.

Here, the digital wallets 110-1, 110-2, . . . , 110-n of a user may be the subjects configured to perform the method for issuing an anonymous delegated credential in a DID-based service according to the embodiment illustrated in FIG. 5, and the method for verifying an anonymous delegated credential in a DID-based service according to the embodiments illustrated in FIGS. 6 and 7. In addition, the service provision server 120 of a verifier may also be the subject configured to perform the method for verifying an anonymous delegated credential in a DID-based service according to an embodiment.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium, an information delivery medium or a combination thereof. For example, the memory 1030 may include Read-Only Memory (ROM) 1031 or Random Access Memory (RAM) 1032.

According to the embodiments disclosed herein, the present disclosure may solve the problems of unnecessary leakage of personal information while maintaining the previous delegation function without change, when consecutive delegated credentials are issued in the DID-based service.

Although the embodiments of the present disclosure have been disclosed with reference to the attached drawing, those skilled in the art will appreciate that the present disclosure can be implemented in other concrete forms, without changing the technical spirit or essential features of the disclosure. Therefore, it should be understood that the foregoing embodiments are merely exemplary, rather than restrictive, in all aspects.

What is claimed is:

1. A method for issuing an anonymous delegated credential in a DID-based service, comprising:
receiving an anonymous delegated credential issuance request message from a digital wallet of a delegatee;
setting attribute values in the anonymous delegated credential;
anonymizing delegator identification information and delegatee identification information among the attribute values; and
issuing the generated anonymous delegated credential to the digital wallet of the delegatee.

2. The method of claim 1, wherein the anonymizing comprises:
extracting and anonymizing the delegatee identification information included in the anonymous delegated credential issuance request message.

3. The method of claim 1, wherein the anonymizing comprises:
anonymizing each of the delegator identification information and the delegatee identification information based on a cryptographic one-way hash function.

4. The method of claim 3, wherein the anonymizing further comprises:
inputting a character string in which issuance dates are respectively connected to the delegator identification information and the delegatee identification information to the cryptographic one-way hash function.

5. The method of claim 1, further comprising:
computing a signature value for the attribute values included in the anonymous delegated credential.

6. The method of claim 1, wherein the anonymous delegated credential is specified in a type attribute among the attribute values.

7. A method for verifying an anonymous delegated credential in a DID-based service, comprising:
acquiring attribute values necessary for verification from an anonymous delegated credential issued from a digital wallet of a delegator;
verifying first anonymous delegator identification information and first anonymous delegatee identification information among the attribute values included in the anonymous delegated credential according to a delegation degree of the anonymous delegated credential; and
verifying an electronic signature value included in the anonymous delegated credential.

8. The method of claim 7, wherein verifying the first anonymous delegator identification information and the first anonymous delegatee identification information is performed when a k-th-degree delegatee is issued a k-th-degree anonymous delegated credential.

9. The method of claim 7, wherein the attributes necessary for verification comprise the first anonymous delegator identification information, the first anonymous delegatee identification information, an issuance date, and the electronic signature value.

10. The method of claim 9, wherein verifying the first anonymous delegator identification information and the first anonymous delegatee identification information comprises:
computing second anonymous delegator identification information based on delegator identification information included in an anonymous delegated credential issuance message;
determining whether the first anonymous delegator identification information is identical to the second anonymous delegator identification information;
computing second anonymous delegatee identification information based on delegatee identification information included in an anonymous delegated credential issuance message; and
determining whether the first anonymous delegatee identification information is identical to the second anonymous delegatee identification information.

11. The method of claim 7, wherein computing the second anonymous delegator identification information and computing the second anonymous delegatee identification information are performed using a cryptographic one-way hash function.

12. The method of claim 7, wherein computing the second anonymous delegator identification information and computing the second anonymous delegatee identification information are performed by inputting, to a cryptographic one-way hash function, a character string in which issuance dates are respectively connected to the delegator identification information and the delegatee identification information.

13. An apparatus for providing an anonymous delegated credential in a DID-based service, comprising:
a memory configured to store at least one program; and
a processor configured to execute the program,
wherein the program is configured to perform:
receiving an anonymous delegated credential issuance request message from a digital wallet of a delegatee;
setting attribute values in the anonymous delegated credential;
anonymizing delegator identification information and delegatee identification information among the attribute values; and
issuing the generated anonymous delegated credential to the digital wallet of a delegatee.

14. The apparatus of claim 13, wherein the program is configured to further perform:
in the anonymizing, extracting and anonymizing the delegatee identification information included in the anonymous delegated credential issuance request message.

15. The apparatus of claim 13, wherein the program is configured to further perform:
in the anonymizing, anonymizing each of the delegator identification information and the delegatee identification information based on a cryptographic one-way hash function.

16. The apparatus of claim 13, wherein the program is configured to further perform:
in the anonymizing, inputting, to the cryptographic one-way hash function, a character string in which issuance dates are respectively connected to the delegator identification information and the delegatee identification information.

17. The apparatus of claim 13, wherein the program is configured to further perform:
computing a signature value for the attribute values included in the anonymous delegated credential.

18. The method of claim 13, wherein the anonymous delegated credential is specified in a type attribute among the attribute values.
